(19) United States
(12) Patent Application Publication
(10) Pub. No.: US 2019/0267009 A1
(43) Pub. Date: Aug. 29, 2019

(54) DETECTION OF A MALICIOUS ATTACK

(71) Applicant: Cirrus Logic International Semiconductor Ltd., Edinburgh (GB)

(72) Inventor: Willem ZWART, Edinburgh (GB)

(73) Assignee: Cirrus Logic International Semiconductor Ltd., Edinburgh (GB)

(21) Appl. No.: 15/906,308

(22) Filed: Feb. 27, 2018

(51) Int. Cl. G10L 17/06; G10L 17/22; G10L 21/0316; G06F 21/32; G06F 21/56

(52) U.S. Cl. CPC G10L 17/06; G10L 17/22; G06F 21/566; G06F 21/32; G10L 21/0316

(57) ABSTRACT

According to embodiments described herein there is provided methods and apparatus for authenticating a first audio signal received at a device. The method comprises receiving the first audio signal at a first input, wherein the first input is for receiving audio signals from a first microphone, receiving a second audio signal at a second input from a second microphone; and comparing a third audio signal derived from the first audio signal to a fourth audio signal derived from the second audio signal. The method further comprises determining, based on the comparison, whether the first audio signal and the second audio signal meet a predetermined condition, wherein the predetermined condition indicates that the first audio signal and the second audio signal are both derived from a common acoustic signal; and using the first audio signal as an input to a voice biometrics module responsive to a determination that the first audio signal and the second audio signal meet the condition.

### TECHNICAL FIELD

Embodiments disclosed herein relate to methods and devices for detecting a malicious attack on a voice biometrics system.

### BACKGROUND

Voice biometric systems are becoming widely used. In such a system, a user trains the system by providing samples of their speech during an enrolment phase. In subsequent use, the system is able to discriminate between the enrolled user and non-registered speakers. Voice biometrics systems can in principle be used to control access to a wide range of services and systems.

One way for a malicious party to attempt to defeat a voice biometrics system is to obtain a recording of, or to synthesise, the enrolled user's speech. In some examples, particularly when an accessory device is used, the false audio may be injected into a signal path between a microphone and the voice biometrics system, which may then fool the voice biometrics system, allowing the malicious party access to services and systems otherwise protected by the voice biometrics system.

### SUMMARY

According to some embodiments there is provided a method for authenticating a first audio signal received at a device. The method comprises receiving the first audio signal at a first input, wherein the first input is for receiving audio signals from a first microphone, receiving a second audio signal at a second input from a second microphone; comparing a third audio signal derived from the first audio signal to a fourth audio signal derived from the second audio signal; determining, based on the comparison, whether the first audio signal and the second audio signal meet a predetermined condition, wherein the predetermined condition indicates that the first audio signal and the second audio signal are both derived from a common acoustic signal; and using the first audio signal as an input to a voice biometrics module responsive to a determination that the first audio signal and the second audio signal meet the condition.

In some embodiments the method comprises receiving the first audio signal at the first input over a first signal path; and receiving the second audio signal at the second input over a second signal path between the second microphone and the second input, wherein the second signal path is more robust than the first signal path.

In some embodiments the method comprises responsive to determining that the first audio signal and the second audio signal meet the predetermined condition, determining that the first audio signal was generated by a first microphone connected to the first input.

In some embodiments the method comprises responsive to determining that the first audio signal and the second audio signal do not meet the predetermined condition, determining that the first audio signal was not generated by a first microphone connected to the first input.

In some embodiments the step of comparing comprises determining a correlation between the third audio signal and the fourth audio signal, or determining a correlation between an envelope of the third audio signal and an envelope of the fourth audio signal.

The step of comparing may comprise determining a time shift between the third audio signal and the fourth audio signal which results in the correlation reaching a maximum value, and wherein determining, whether the first audio signal and the second audio signal meet a predetermined condition comprises comparing the maximum value to a threshold value.

In some embodiments the method comprises determining a time shift between the third audio signal and the fourth audio signal which results in a cross-correlation between the third audio signal and the fourth audio signal reaching a maximum value, and wherein determining whether the first audio signal and the second audio signal meet a predetermined condition comprises comparing the maximum value to a threshold value.

In some embodiments the method comprises determining that the first audio signal and the second audio signal meet the predetermined condition responsive to determining that the maximum value is above the threshold value.

In some embodiments the third audio signal comprises the first audio signal. In some embodiments the fourth audio signal comprises the second audio signal.

In some embodiments the method comprises generating the fourth audio signal by increasing the gain of the second audio signal. The method may comprise generating the fourth audio signal by increasing the gain of the second audio signal during the comparison, and/or by increasing the gain of the second audio signal before performing the comparison.

In some embodiments the method comprises normalising the amplitudes of the first audio signal and the second audio signal to generate the third audio signal and the fourth audio signal respectively.

In some embodiments the method comprises performing the step of comparing responsive to receiving a request to perform the comparison. The request may be transmitted responsive to a determination that the first audio signal comprises a command associated with an action configured as a high security action. The request may be transmitted responsive to a determination that a characteristic of the first audio signal differs from a predetermined expected characteristic. The characteristic may comprise an audio quality of the first audio signal.

In some embodiments the method comprises storing the first audio signal in a first buffer, and storing the second audio signal in a second buffer.

According to some embodiments there is provided a microphone signal authentication module for validating a first audio signal. The microphone signal authentication module comprises a first input for receiving a first audio signal; a second input for receiving a second audio signal generated by a second microphone; an audio signal comparison module configured to compare a third audio signal derived from the first audio signal to a fourth audio signal derived from the second audio signal; a determination block configured to determine, based on the comparison, whether the first audio signal and the second audio signal meet a predetermined condition, wherein the predetermined condition indicates that the first audio signal and the second audio signal are both derived from a common acoustic signal; and a voice biometrics module configured to use the first audio signal as an input responsive to a determination that the first audio signal and the second audio signal meet the predetermined condition.

In some embodiments the first audio signal is received over a first signal path, and the second audio signal is received over a second signal path between the second microphone and the second input, wherein the second signal path is more robust that the first signal path.

In some embodiments the determination block is configured to, responsive to a determination that the first audio signal and the second audio signal meet the predetermined condition, determine that the first audio signal was generated by a first microphone connected to the first input.

In some embodiments the determination block is further configured to, responsive to a determination that the first audio signal and the second audio signal do not meet the predetermined condition, determine that the first audio signal was not generated by a first microphone connected to the first input.

In some embodiments the comparison module is configured to compare the third audio signal to the fourth audio signal by determining a correlation between the third audio signal and the fourth audio signal.

In some embodiments the comparison module is configured to determine a correlation between an envelope of the third audio signal and an envelope of the fourth audio signal.

In some embodiments the comparison module is configured to determine a time shift between the third audio signal and the fourth audio signal which results in a cross correlation between the third audio signal and the fourth audio signal reaching a maximum value, and the determination block is configured to determine whether the first audio signal and the second audio signal meet a predetermined condition by comparing the maximum value to a threshold value.

In some embodiments the determination block is configured to determine that the first audio signal and the second audio signal meet the predetermined condition responsive to determining that the maximum value is above the threshold value.

In some embodiments the determination block is configured to determine that the first audio signal and the second audio signal meet the predetermined condition responsive to determining that the time shift between the first audio signal is within an allowable range of time shifts.

In some embodiments the third audio signal comprises the first audio signal. In some embodiments the fourth audio signal comprises the second audio signal.

In some embodiments the microphone signal authentication module further comprises an amplification module configured to generate the fourth audio signal by increasing the gain of the second audio signal.

In some embodiments the amplification module is configured to generate the fourth audio signal by increasing the gain of the second audio signal during the comparison and/or by increasing the gain of the second audio signal before performing the comparison.

In some embodiments the microphone signal authentication module further comprises a normalisation module configured to normalise the amplitudes of the first audio signal and the second audio signal to generate the third audio signal and the fourth audio signal respectively.

In some embodiments the comparison module is configured to compare the third audio signal to the fourth audio signal responsive to receiving a request from the voice biometrics module to perform the comparison.

In some embodiments comparison module is configured to receive the request responsive to a determination that the first audio signal comprises a command associated with one of a plurality of predefined high security actions.

In some embodiments the comparison module is configured to receive the request responsive to a determination that a characteristic of the first audio signal differs from a predetermined expected characteristic.

In some embodiments the microphone signal authentication module further comprises a first buffer for storing the first audio signal and a second buffer for storing the second audio signal. In some embodiments the comparison module is configured to receive the first audio signal and the second audio signal from the first buffer and the second buffer respectively.

According to some embodiments there is provided a system comprising a microphone signal authentication module as described above.

In some embodiments system further comprises the second microphone connected to the second input. In some embodiments in the system the voice biometrics module is further configured to perform voice biometrics on the first audio signal.

In some embodiments in the system the first input is connected to an accessory device, wherein the accessory device comprises the first microphone.

In some embodiments the accessory device is connected to the first input by one of: an audio jack, a Universal Serial Bus (USB) connection, a Bluetooth connection or any other wired/wireless connection.

According to some embodiments there is provided an electronic apparatus comprising a system as described above.

The electronic apparatus may be at least one of: a portable device; a battery power device; a computing device; a communications device; a gaming device; a mobile telephone; a personal media player; a laptop, tablet or notebook computing device.

According to some embodiments there is provided software code stored on a non-transitory storage medium which, when run on a suitable processor, performs the method as described above or provides the system as described above. In some embodiments the software code is stored in memory of an electronic device.

According to some embodiments there is provided an electronic device comprising memory containing software code and a suitable processor for performing the method as described above.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 illustrates an electronic device having a voice authentication module;

FIG. 2 illustrates a microphone signal authentication module according to some embodiments;

FIG. 3a illustrates an example where the first audio signal and the second audio signal are derived from a common acoustic signal;

FIG. 3b illustrates an example where the first audio signal and the second audio signal are not derived from a common acoustic signal;

FIG. 4 illustrates a microphone signal authentication module according to some embodiments;

FIG. 5 illustrates a microphone signal authentication module according to some embodiments;

FIG. 6 illustrates a method for authenticating a first audio signal received at a device.

### DESCRIPTION

The description below sets forth example embodiments according to this disclosure. Further example embodiments and implementations will be apparent to those having ordinary skill in the art. Further, those having ordinary skill in the art will recognize that various equivalent techniques may be applied in lieu of, or in conjunction with, the embodiments discussed below, and all such equivalents should be deemed as being encompassed by the present disclosure.

Embodiments of the present disclosure relate to methods and apparatus for authenticating a first audio signal, in particular for verifying the source of the first audio signal. In particular, the present embodiments relate to verifying or authenticating that a particular audio signal was not the result of a malicious attack. The microphone authentication apparatus may, for example, determine whether a second audio signal received over a robust signal path from a second microphone, is similar to the first audio signal. If not, this may suggest that the first audio signal was not derived from the same acoustic signal as the second audio signal, and that therefore the first audio signal may be the result of an attack by a malicious third party.

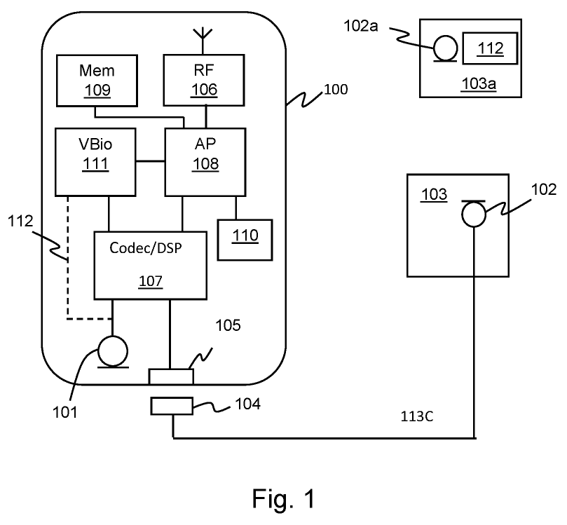

FIG. 1 illustrates one example of an electronic device 100, such as a mobile telephone or tablet computer for example. It will be appreciated that the electronic device 100 may in practice contain many other components, but the following description is sufficient for an understanding of the embodiments described herein. The electronic device 100 may comprise at least one microphone 101 for providing audio signals corresponding to detected acoustic signals, for example sounds. A microphone 101 of the electronic device 100 may provide an analogue microphone audio signal but in some embodiments the microphone 101 may be a digital microphone that outputs a digital microphone audio signal.

Additionally or alternatively the device 100 may be operable, in use, to receive audio signals from at least one external microphone 102 of an accessory apparatus. An accessory apparatus 103 may, in some instances, be removably physically connected to the electronic device 100 for audio data transfer, for instance by a connector 104 of the accessory apparatus making a mating connection with a suitable connector 105 of the electronic device. In some examples, this connection may comprise an audio jack or a Universal Serial Bus (USB). Audio data received from the accessory apparatus 103, may be analogue or may, in some instances, comprise digital audio data.

In some instances, an accessory apparatus 103a may be configured for local wireless transfer of audio data from a microphone 102a of the accessory apparatus 103a to the electronic device 100, for instance via a wireless module 106 of the electronic device 100. Such wireless transfer could be via any suitable wireless protocol such as WiFi or Bluetooth™ for example.

Audio data from an on-board microphone 101 of the electronic device 100 and/or audio data from a microphone 102/102a of the accessory apparatus 103/103a may be processed in a variety of different ways depending on the operating mode or use case of the electronic device 100 at the time. Conveniently, at least some processing is applied in the digital domain and thus, if necessary, the received microphone data may be converted to digital microphone data. The digital microphone data may be processed by audio processing circuitry 107 which may, for instance comprise an audio codec and/or a digital signal processor (DSP) for performing one or more audio processing functions, for instance to apply gain and/or filtering to the signals, for example for noise reduction.

A control processor 108 of the electronic device, often referred to as an applications processor (AP), may control at least some aspects of operation of the electronic device 100 and may determine any further processing and/or routing of the received microphone data. For instance, for telephone communications the received microphone data may be forwarded to the wireless module 106 for broadcast. For audio or video recording the microphone data may be forwarded to a memory 109 for storage. For voice control of the electronic device 100 the microphone data may be forwarded to a speech recognition module 110 to distinguish voice command keywords.

The device 100 may also comprise a voice biometrics module 111 for analysing microphone data received from any one of microphones 101, 102 and/or 102a and determining whether the audio data corresponds to the voice of a registered user, i.e. for performing speaker recognition.

The voice biometrics module 111 receives input data, e.g. from the microphone 101, and compares characteristics of the received data with user-specific reference templates specific to a respective pre-registered authorized user (and maybe, for comparison, also with reference templates representative of a general population). Voice/speaker recognition techniques and algorithms are well known to those skilled in the art and the present disclosure is not limited to any particular voice recognition technique or algorithm.

The voice biometrics module 111 may be activated according to a control input conveying a request for voice biometric authentication, for example from the AP 108.

For example, a particular use case running on the AP 108 may require authentication to wake the device 100, or to authorize some command, e.g. a financial transaction. If the received audio data corresponds to an authorized user, the voice biometrics module 111 may indicate this positive authentication result, for example by a signal BioOK which is sent to the AP 108. The AP 108 (or a remote server that has requested the authentication) may then act on the signal as appropriate, for example, by authorizing some activity that required the authentication, e.g. a financial transaction. If the authentication result was negative, the activity, e.g. financial transaction, would not be authorised.

In some embodiments, the voice biometrics module 111 may be enabled by a voice activity event which is detected, for example, by the Codec/DSP 107 or another dedicated module (not shown). For example, when the device 100 is in a low-power sleep mode, any voice activity may be detected and a signal VAD (voice activity detected) communicated to the voice biometrics module 111. In the event of a positive user authentication, the signal BioOK may be used by the AP 108 to alter the state of the device 100 from the low-power sleep mode to an active mode (i.e. higher power). If the authentication result were negative, the mode change may not be activated.

In some embodiments, there may be a signal path 112 for providing audio data directly from a microphone 101 to the voice biometrics module 111 for the purposes of voice authentication. However in at least some embodiments and/or for some use cases audio data from microphone 101 of the electronic device 100 or from a microphone 102 of an accessory apparatus 103 may be provided to the voice authentication module 111 via the AP 108 and/or via Codec/DSP 107 or via a signal path including some other processing modules.

Whilst voice biometrics module 111 has been illustrated as a separate module in FIG. 1 for ease of reference it will be understood that the voice biometrics module 111 could be implemented as part of or integrated with one or more of the other modules/processors described, for example, with speech recognition module 110. In some embodiments, the voice biometrics module 111 may be a module at least partly implemented by the AP 108 which may be activated by other processes running on the AP 108. In other embodiments, the voice biometrics module 111 may be separate to the AP 108 and in some instances, may be integrated with at least some of the functions of the Codec/DSP 107.

As used herein, the term ‘module’ shall be used to at least refer to a functional unit of an apparatus or device. The functional unit may be implemented at least partly by dedicated hardware components such as custom defined circuitry and/or at least partly be implemented by one or more software processors or appropriate code running on a suitable general purpose processor or the like. A module may itself comprise other modules or functional units. The term “block” shall be in the same way as module.

The voice biometrics module 111 thus provides a way for a user to verify that they are an authorised user in order to access some information or service. As mentioned the voice authorisation may be used to access sensitive information and/or authorise financial transactions etc. Such an authentication may, in practice, be subject to an attack, i.e. an attempt by an unauthorised user to falsely obtain access to the information or service.

There are various ways in which a voice authentication system for an electronic device such as a smartphone or the like could potentially be attacked. In theory, if an attacker had access to the device itself, the attacker could attempt to interfere with the operation of the voice biometrics module 111 of the device, by electrically modifying the module, however such an attack would have a number of practical difficulties and may not be of significant concern or could be protected against by some anti-tamper measures.

The voice biometrics module 111 itself may thus be considered secure, in that an authentication signal from the voice biometrics module 111 cannot be faked, for example, the voice biometrics module 111 will only generate an authentication signal indicating that authentication is successful if the audio input supplied to the voice biometrics module 111 does match the registered user.

However, it is conceivable that an attacker could generate false audio data and attempt to provide said false audio to the voice authentication module 111 as if it were genuine audio data from a registered user speaking at that time, the false data being selected to have a high chance of being falsely recognised as matching the registered user.

For instance, it may be possible for an attacker to defeat voice authentication by recording a registered user speaking without their knowledge and using such recording later when attacking a secure service. Such recorded audio may thus genuinely correspond to the registered user, but is used falsely during an attempt to access some service which is not authorised by the registered user.

There are various routes in which such false audio could be supplied to the voice authentication module 111.

For example, the connections between an accessory device such as devices 103 and 103a may be tampered with, and the false audio may be introduced into the signal path between the microphone 102/102a and the voice biometrics module 111.

In some examples, the signal path between such an accessory device 103/103a and the voice biometrics module 111 may be considered less robust that the signal path 112 between an on-board microphone 101 and the voice biometrics module. In other words, the signal paths between the accessory devices and the voice biometrics module 111 may be more vulnerable to tampering from malicious third parties, in particular more vulnerable to an electronic injection attack.

A robust signal path may comprise different hardware and/or software features which make the signal path more difficult for an attacker to intercept and/or more difficult for an attacker to insert data via the signal path. In some examples, a robust signal path may comprise mechanical covers and/or anti-tamper measures, and/or may have signal encoding or encryption measures which prevent access to the communicated data.

A signal path which is not robust may, for example, be a simple audio cable which can be relatively easily cut and spliced with another cable. In other examples, a non-robust signal path may comprise a Bluetooth data connection where an attacker may easily access the signal path directly on the accessory itself, or provide a spoofed wireless signal to replace the true signal.

In the example device 100 illustrated in FIG. 1 therefore, the signal path between the microphone 101 and the voice biometrics module 111, whether via the Codec 107 or not, may, in some embodiments, be considered to be more robust than the signal path between the voice biometrics module 111 and either of the microphones 102 or 102a in the example accessory devices 103 and 103a. It will be appreciated that in some embodiments, a signal path to a microphone in an accessory device may be considered robust, whilst a signal path to an on-board microphone may not be considered to be robust.

Embodiments described herein make use of signal paths which are considered to be robust to determine whether or not another signal path has been tampered with. For example, if a first audio signal is received at a first input (which may be an input expecting to receive audio signals from a first microphone) a second audio signal, received from a second microphone over a robust second signal path may be used to determine whether or not the first audio signal was generated by a microphone in the vicinity of the second microphone.

In other words, if the signals received at both inputs are similar, or contain features which indicate that the audio signals are both derived from the same acoustic signal, then it may be unlikely that the non-robust signal path has been subject to a malicious attack. However, if the first audio signal is not similar to the second audio signal, this may be indicative of some tampering occurring in the signal path between the first microphone and the first input.

It should be noted that as used herein the term “audio” is not intended to refer to signals at any particular frequency range and is not used to specify the audible frequency range. The audio signal may encompass an audible frequency range and where the audio signal is provided for voice biometric authentication the audio signal will encompass a frequency band suitable for voice audio. However the audio signal which is verified may additionally or alternatively comprise higher frequencies, e.g. ultrasonic frequencies or the like. The term audio signal is intended to refer to a signal of the type which may have originated from a microphone, possibly after some processing.

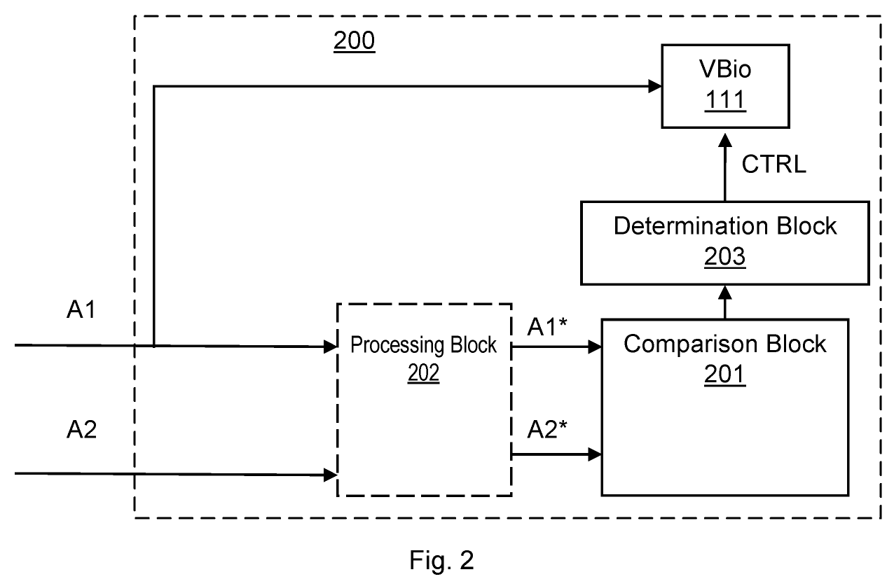

FIG. 2 illustrates a microphone signal authentication module 200 for validating a first audio signal A1. The microphone authentication module 200 comprises a first input for receiving a first audio signal A1 and a second input for receiving a second audio signal A2. The second audio signal A2 may be generated by a second microphone and may be received at the second input over a more robust signal path than the signal path to the first input. It will be appreciated that the first audio signal and the second audio signal may comprise digital or analogue signals.

For example, the second audio signal A2 may be generated by an on-board second microphone such as microphone 101 illustrated in FIG. 1. The first audio signal A1 may be received over a non-robust signal path, for example from an accessory connection at the device. For example, the first audio signal A1 may be received via an accessory connector 105 or a wireless module 106, as illustrated in FIG. 1. It will be appreciated that the first audio signal A1 may therefore have been generated by a microphone such as one of microphones 102 or 102a on an accessory device. However, the first audio signal A1 may also be the result of a malicious attack, such as an electronic injection attack, on the signal path between the microphone signal authentication module 200 and the microphone 102 or 102a.

The microphone signal authentication module 200 comprises an audio signal comparison module 201 configured to compare a third signal A1* derived from the first audio signal A1 to a fourth signal A2* derived from the first audio signal. In other words, the first audio signal A1 may be processed by a processing block 202 before being input into the audio signal comparison module 201. Similarly, the second audio signal A2 may be processed by the processing block 202 before being input into the audio signal comparison module 201. It will be appreciated that in some embodiments, only one of the first and second audio signals is processed, or neither of the first and second audio signals are processed.

In some embodiments, it will be appreciated that the third audio signal A1* may comprise the first audio signal A1 and the fourth signal A2* may comprise the second audio signal A2*. In other words, in some embodiments, no processing may be performed on one or both of the first and second audio signals.

The microphone signal authentication module 200 further comprises a determination block 203 configured to determine, based on the comparison, whether the first audio signal A1 and the second audio signal A2 meet a predetermined condition, wherein the predetermined condition indicates that the first audio signal A1 and the second audio signal A2 are both derived from a common acoustic signal. For example, the predetermined condition may comprise a condition that a level correlation between the third audio signal A1* and the fourth audio signal A2* is above a predetermined threshold.

The microphone signal authentication module further comprises a voice biometrics module 111, such as the voice biometrics module 111 illustrated in FIG. 1. The voice biometrics module 111 is configured to use the first audio signal A1 as an input responsive to a determination that the first audio signal A1 and the second audio signal A2 meet the predetermined condition. It will be appreciated that in some embodiments, the voice biometrics module may use the third audio signal A1* as an input.

For example, the voice biometrics module 111 may be configured to receive the first audio signal A1, and may also be configured to receive a control signal CTRL from the determination block 203. The control signal CTRL may indicate whether or not the first audio signal A1 and the second audio signal A2 meet the predetermined condition. The voice biometrics module 111 may in this example be configured to determine whether or not to use the first audio signal A1 as an input based on the received control signal CTRL.

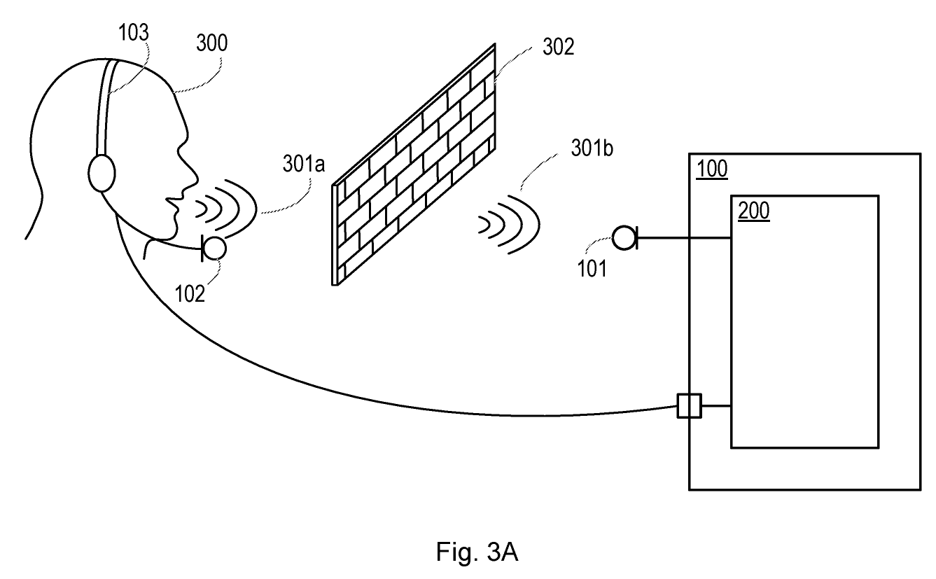

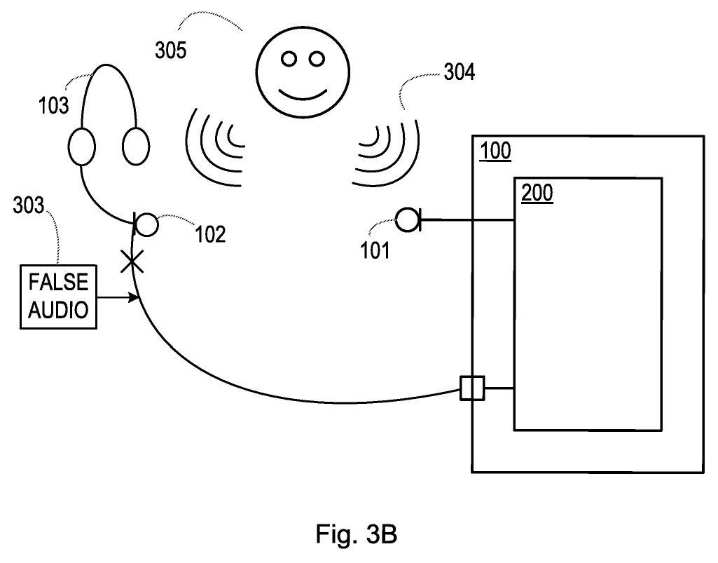

FIG. 3a illustrates an example where the first audio signal and second audio signal are generated from a common acoustic signal.

In this example, the common acoustic signal comprises the acoustic signal 301a produced when a person 300 speaks. The acoustic signal 301a is detected by a first microphone 102 attached to the accessory device 103.

The signal 301b detected by a second microphone 101 on-board the device 100 may have been distorted by an obstruction 302, but it is still, in this example, derived from the original acoustic signal 301a.

The obstruction 302 may, for example, be due to the device 100 being located in a user's pocket when the user is speaking into the accessory device 103.

FIG. 3b illustrates an example of the first audio signal and the second audio signal not being generated from a common acoustic signal.

Similarly to the above, the device 100 may be connected to an accessory device 103. The accessory device 103 may comprise a first microphone 102, but the signal path between the first microphone 102 and the microphone signal authentication module 200 has been attacked. In this example therefore a false audio signal 303 has been inserted into the signal path between the first microphone 102 and the microphone signal authentication module 200.

Therefore, the acoustic signal 304 picked up by the second microphone 101, will not correlate with the signal received at the second input to the microphone signal authentication module 200. Even if an acoustic source 305 (here illustrated as a person but it will be appreciated that there may be any type of acoustic source) was in the vicinity of both the second microphone 101 and the first microphone 102, the signal generated by the first microphone 102 would not reach the microphone signal authentication module 200.

It will be appreciated, that in some embodiments, the first microphone 102 may be removed from the signal path to the second input of the microphone signal authentication module 200 entirely.

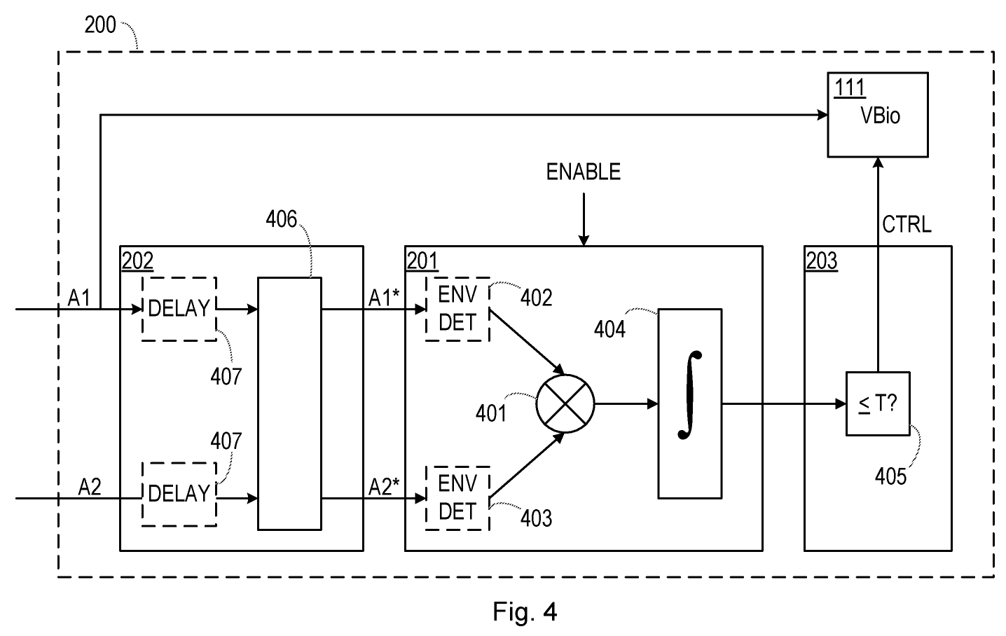

Returning to FIG. 2, in some embodiments, the audio signal comparison module 201 is configured to compare the third audio signal A1* and the fourth audio signal A2* by determining a correlation between the third audio signal A1* and the fourth audio signal A2*. FIG. 4 illustrates an example of an audio signal authentication module 200.

The audio signal comparison module 201 may be configured to receive the third audio signal A1* and the fourth audio signal A2* and to correlate the third audio signal A1* and the fourth audio signal A2* at a correlation element 401.

In some example embodiments, the comparison module 201 optionally comprises a first envelope detection block 402 and a second envelope detection block 403. In these examples, the comparison module 201 may be configured to correlate the envelope of the third audio signal A1*, output from the first envelope detection block 402, and the envelope of the fourth audio signal A2*, output from the second envelope detection block 403.

The audio signal comparison module 201 may then further comprise an integration block 404 configured to integrate the result of the correlation. The result of the integration may be used as an indication of the level of correlation between the fourth audio signal A2* and the third audio signal A1* and may be output to the determination block 203.

The determination block 203 may then compare the result of the integration to a threshold 405 to determine whether or not the third audio signal A1* and fourth audio signal A2* have a high enough correlation to indicate that they, and therefore the first audio signal A1 and second audio signal A2, were derived from a common acoustic signal.

In some embodiments, a delay module 407 may be provided in the A1 or A2 paths, the delay module may be configured to apply a delay to the first audio signal A1 and/or the second audio signal A2 to account for differences in the overall delay in the signal paths from the source of the acoustic signal to the microphone signal authentication module 200.

Alternatively, the audio signal comparison module 201 may be configured to perform a cross-correlation of the third and fourth signals A1*, A2* to determine a time shift between the third audio signal A1* and the fourth audio signal A2* that results in the cross-correlation reaching a maximum value. The maximum value of the correlation may then be compared to a threshold value T in the determination block 203. The determined time shift may also be compared to a range of allowable time shifts. The range of allowable time shifts may be times shifts which would be expected in the receipt of the first and second audio signals A1 and A2 due to the differences in the signal paths of A1 and A2. If the maximum value is above the threshold value the determination block 203 may determine that the signal A1 is authenticated. In some embodiments the determination block 203 may only authenticate the first audio signal A1 responsive to the time shift being within the allowable range of this shifts. In some embodiments therefore, if either of these conditions is not met, then the first audio signal A1 is not authenticated.

It will however be appreciated that in some embodiments only the maximum value is used to determine whether the first audio signal A1 is authenticated.

As described above, in some embodiments, the microphone signal authentication module 200 comprises a processing block 202 configured to process the first and/or second audio signals before inputting the third audio signal A1* and the fourth audio signal A2* into the comparison module 201. For example, the processing block 202 may be configured to process the second audio signal A2 to compensate for any noise or reduced quality of the second audio signal.

For example, as illustrated in FIG. 3a and FIG. 3b in some embodiments the second audio signal A2 is generated by a second microphone on-board the device 100, and the first audio signal A1 is generated by a microphone located in an accessory device (FIG. 3a), or by a malicious attack on an accessory device (FIG. 3b). In these examples, the quality of the second audio signal A2 generated by the microphone may by altered by the location of the device, which may, for example, have been placed in the pocket of a user. As described previously, there may therefore be some obstruction 302 distorting the acoustic signal 301a before reaching the second microphone.

In the embodiment illustrated in FIG. 4 therefore, the processing block 202 comprises a normalising module 406 configured to normalise the amplitudes of the first audio signal A1 and the second audio signal A2 to generate the third audio signal A1* and the fourth audio signal A2*. This normalisation may compensate for any distortion or reduction in amplitude of the acoustic signal 301b. By normalising the first audio signal and the second audio signal the level of correlation between the two signals may be maximised.

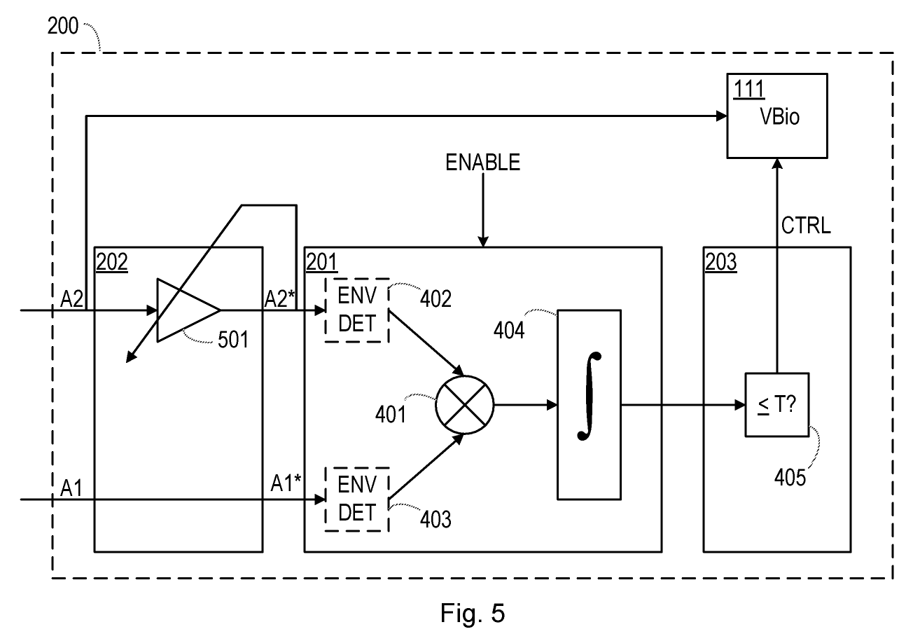

In some examples, the processing block 202 comprises an amplification module 501 configured to increase the gain of the second audio signal A2 to generate the fourth audio signal A2*, as illustrated in FIG. 5 (in which similar components have been given the same reference numbers as those used in FIG. 4).

In the example illustrated in FIG. 5, the processing module 202 may be configured to increase the gain of the second audio signal A2 during the comparison, in other words, the fourth audio signal A2* may comprise an output of a variable gain module 501 for which the input is the second audio signal A2. Therefore in the example described above In FIG. 3a or 3b, if there is no or insignificant obstruction between the second microphone and the acoustic source, it may not be necessary to increase the gain of the second audio signal A2 in order to provide a meaningful comparison. However, if the amplitude of the second audio signal A2 is low, for example due to some obstruction, the gain of the second audio signal A2 may be increased during the comparison in order to increase the signal to noise ratio of the fourth audio signal A2, and thereby improve the correlation between the fourth audio signal A2* and the third audio signal A1*.

In some examples, the output of the variable gain module 501 may be fed back to the variable gain module in order to control the gain applied to the second audio signal A2. In some examples, the feedback may be taken from the output of the envelope detection block 402.

It will also be appreciated that in some embodiment, additionally or alternatively, a variable gain module may be included in the signal path between the first audio signal A1 and the third audio signal A1*.

In some embodiments, as illustrated in FIGS. 4 and 5 the comparison module 201 is configured to perform the comparison responsive to receiving a request to perform the comparison. In FIGS. 4 and 5 this request is depicted by an ENABLE command. The request may be transmitted by the voice biometrics module 111, or be some other control module in communication with the microphone signal authentication module 200.

In some examples, the request is transmitted responsive to a determination that the first audio signal A1 comprises a command associated with an action configured as a high security action. For example, the first audio signal may also be received by a speech recognition module 110 configured to identify spoken words within the first audio signal. If for example, the speech recognition module 110 recognises than the first audio signal comprises a command, for example, “play music” or “transfer £1000 to Mr. X”, the speech recognition module 110 may determine whether the command is associated with an action configured as a high security action.

A high security action may be internally preconfigured within the device as an action for which it is important that malicious attacks on the voice biometrics system are detected. For example, it will be appreciated that it may be considered more important to detect such attacks issuing commands associated with actions relating to money transfers than attacks issuing commands associated with playing music.

However, exactly which actions and/or commands are considered high security may be individual to a particular device, or set by a user of the device.

In response to determining that the command is associated with a high security action, the speech recognition module may enable the comparison module 202, which may then only allow the first audio signal A1 to be used as an input for the voice biometrics module 111, if there does not appear to be a malicious attack on the first audio signal. In other words, for the high security actions, the comparison performed by the microphone signal authentication module 200 may be enabled as an extra layer of protection.

Having the flexibility to select or preconfigure which commands or actions are considered high security, allows the device to save power by not performing the comparison for low security commands.

In some examples, the request is transmitted responsive to a determination that a characteristic of the first audio signal differs from a predetermined expected characteristic. For example, the device may be configured to enable the comparison module if the quality of the first audio signal is better than would ordinarily be expected. A high audio quality may, for example, indicate that the audio has been synthesised, and may therefore be more likely to be the result of a malicious attack.

In some embodiments, in order to allow for the time required to allow the device to determine whether or not to enable the comparison module 201 the microphone signal authentication module 200 may comprise a first buffer configured to store the first audio signal, and a second buffer configured to store the second audio signal.

It will be appreciated that in some embodiments, the comparison module may always be enabled.

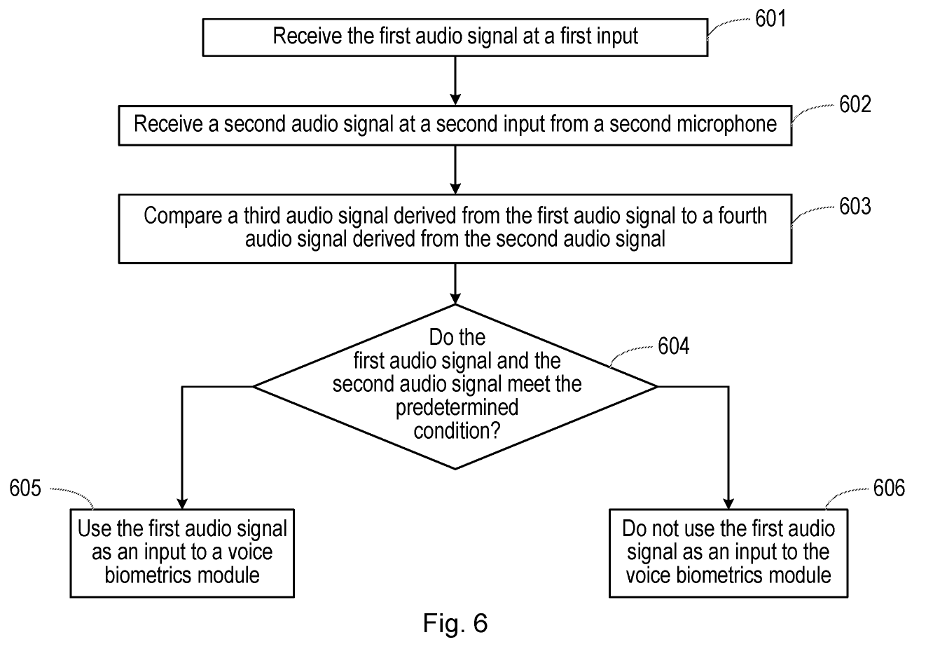

FIG. 6 illustrates a method for authenticating a first audio signal received at a device. The method comprises, in step 601 receiving the first audio signal at a first input, wherein the first input is for receiving audio signals from a first microphone. For example, the first input may be connected to receive audio signals from a wireless module 106 or audio connection point 105 as illustrated in FIG. 1. In some examples, the first audio signal is received at the first input over a first signal path.

In step 602 the method comprises receiving a second audio signal at a second input from a second microphone. In some examples, the second audio signal is received at the second input over a second signal path between the second microphone and the second input. The second signal path may be more robust than the first signal path.

In step 603 the method comprises comparing a third audio signal derived from the first audio signal to a fourth audio signal derived from the second audio signal. In some embodiments, the third audio signal comprises the first audio signal. In some embodiments the fourth audio signal comprises the second audio signal. In some embodiments, the third audio signal is generated by processing the first audio signal. In some embodiments, the fourth audio signal is generated by processing the second audio signal.

In some examples, the method comprises generating the fourth audio signal by increasing the gain of the second audio signal. For example, the method may comprise generating the fourth audio signal by increasing the gain of the second audio signal during the comparison. Additionally or alternatively, the method may comprise generating the fourth audio signal by increasing the gain of the second audio signal before performing the comparison.

In some embodiments, the method may comprise normalising the amplitudes of the first audio signal and the second audio signal to generate the third audio signal and the fourth audio signal respectively.

In some examples, step 603 comprises determining a correlation between the third audio signal and the fourth audio signal. For example step 603 may comprise determining a correlation between an envelope of the third audio signal and an envelope of the audio fourth signal.

In step 604 the method comprises determining, based on the comparison, whether the first audio signal and the second audio signal meet a predetermined condition, wherein the predetermined condition indicates that the first audio signal and the second audio signal are both derived from a common acoustic signal. For example, the predetermined condition may comprise a condition that the level of correlation between the third audio signal and the fourth audio signal is above a predetermined threshold.

In some embodiments, responsive to determining that the first audio signal and the second audio signal meet the predetermined condition, the method may comprise determining that the first audio signal was generated by a first microphone connected to the first input. Conversely, responsive to determining that the first audio signal and the second audio signal do not meet the predetermined condition, the method may comprise determining that the first audio signal was not generated by a first microphone connected to the first input. In these circumstances, the method may comprise determining that a malicious attack on the signal path to the first input has taken place.

If in step 604 the method determined that the first audio signal and the second audio signal do meet the predetermined condition, the method passes to step 605. In step 605 the method comprises using the first audio signal as an input to a voice biometrics module responsive to the determination that the first audio signal and the second audio signal meet the condition. In other words, if in step 604 it is determined that the first audio signal was generated by a first microphone connected to the first input, it may be determined that the signal path to the first input has not been subject to a malicious attack, and that therefore the first audio signal may be used as an input to the voice biometrics module.

If in step 604, the method determines that the first audio signal and the second audio signal do not meet the predetermined condition, the method passes to step 606. In step 606 the method comprises not using the first audio signal as an input to a voice biometrics module. In other words, if in step 604 it is determined that the first audio signal was not generated by a first microphone connected to the first input, it may be determined that the signal path to the first input has been subject to a malicious attack, and that therefore the first audio signal should not be used as an input to the voice biometrics module.

In some embodiments, as described above with reference to FIGS. 4 and 5, the method further comprises performing step 603 responsive to receiving a request to perform the comparison. In some examples, the request is transmitted responsive to a determination that the first audio signal comprises a command associated with an action configured as a high security action. In some examples, the request is transmitted responsive to a determination that a characteristic of the first audio signal differs from a predetermined expected characteristic. As described above, the characteristic may comprise an audio quality of the first audio signal.

In some embodiments, as described above, the method may further comprise storing the first audio signal in a first buffer, and storing the second audio signal in a second buffer.

It will be appreciated, that the microphone authentication apparatus 200 illustrated in any one of FIG. 2, 4 or 5 may be operable to perform the method as described with relation to FIG. 6.

The skilled person will recognise that some aspects of the above-described apparatus and methods may be embodied as processor control code, for example on a non-volatile carrier medium such as a disk, CD- or DVD-ROM, programmed memory such as read only memory (Firmware), or on a data carrier such as an optical or electrical signal carrier. For many applications embodiments of the invention will be implemented on a DSP (Digital Signal Processor), ASIC (Application Specific Integrated Circuit) or FPGA (Field Programmable Gate Array). Thus the code may comprise conventional program code or microcode or, for example code for setting up or controlling an ASIC or FPGA. The code may also comprise code for dynamically configuring re-configurable apparatus such as re-programmable logic gate arrays. Similarly the code may comprise code for a hardware description language such as Verilog™ or VHDL (Very high speed integrated circuit Hardware Description Language). As the skilled person will appreciate, the code may be distributed between a plurality of coupled components in communication with one another. Where appropriate, the embodiments may also be implemented using code running on a field-(re)programmable analogue array or similar device in order to configure analogue hardware.

Embodiments may be implemented in a host device, especially a portable and/or battery powered host device such as a mobile computing device for example a laptop or tablet computer, a games console, a remote control device, a home automation controller or a domestic appliance including a domestic temperature or lighting control system, a toy, a machine such as a robot, an audio player, a video player, or a mobile telephone for example a smartphone.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single feature or other unit may fulfil the functions of several units recited in the claims. Any reference numerals or labels in the claims shall not be construed so as to limit their scope.

1. A method for authenticating a first audio signal received at a device, the method comprising:
receiving the first audio signal at a first input, wherein the first input is for receiving audio signals from a first microphone,
receiving a second audio signal at a second input from a second microphone;
comparing a third audio signal derived from the first audio signal to a fourth audio signal derived from the second audio signal;
determining, based on the comparison, whether the first audio signal and the second audio signal meet a predetermined condition, wherein the predetermined condition indicates that the first audio signal and the second audio signal are both derived from a common acoustic signal; and
using the first audio signal as an input to a voice biometrics module responsive to a determination that the first audio signal and the second audio signal meet the condition.

2. The method as claimed in claim 1 further comprising:
receiving the first audio signal at the first input over a first signal path; and
receiving the second audio signal at the second input over a second signal path between the second microphone and the second input, wherein the second signal path is more robust than the first signal path.

3. The method as claimed in claim 1 further comprising responsive to determining that the first audio signal and the second audio signal meet the predetermined condition, determining that the first audio signal was generated by a first microphone connected to the first input.

4. The method as claimed in claim 1 wherein the step of comparing comprises determining a correlation between the third audio signal and the fourth audio signal.

5. The method as claimed in claim 4 wherein the step of comparing comprises determining a correlation between an envelope of the third audio signal and an envelope of the fourth audio signal.

6. The method as claimed in claim 1 wherein the step of comparing comprises determining a time shift between the third audio signal and the fourth audio signal which results in a cross-correlation between the third audio signal and the fourth audio signal reaching a maximum value, and wherein determining whether the first audio signal and the second audio signal meet a predetermined condition comprises comparing the maximum value to a threshold value.

7. The method as claimed in claim 6 further comprising:
determining that the first audio signal and the second audio signal meet the predetermined condition responsive to determining that the maximum value is above the threshold value.

8. The method as claimed in claim 7 further comprising:
determining that the first audio signal and the second audio signal meet the predetermined condition responsive to determining that the time shift is within an allowable range of time shifts.

9. The method as claimed in claim 1 wherein the third audio signal comprises the first audio signal.

10. The method as claimed in claim 1 wherein the fourth audio signal comprises the second audio signal.

11. The method as claimed in claim 1 further comprising generating the fourth audio signal by increasing the gain of the second audio signal.

12. The method as claimed in claim 11 further comprising generating the fourth audio signal by increasing the gain of the second audio signal during the comparison.

13. The method as claimed in claim 11 further comprising generating the fourth audio signal by increasing the gain of the second audio signal before performing the comparison.

14. The method as claimed in claim 1 further comprising;
normalising the amplitudes of the first audio signal and the second audio signal to generate the third audio signal and the fourth audio signal respectively.

15. The method as claimed in claim 1 further comprising performing the step of comparing responsive to receiving a request to perform the comparison.

16. The method as claimed in claim 15 wherein the request is transmitted responsive to a determination that the first audio signal comprises a command associated with an action configured as a high security action.

17. The method as claimed in claim 15 wherein the request is transmitted responsive to a determination that a characteristic of the first audio signal differs from a predetermined expected characteristic.

18. The method as claimed in claim 17 wherein the characteristic comprises an audio quality of the first audio signal.

19. The method as claimed in claim 1 further comprising storing the first audio signal in a first buffer, and storing the second audio signal in a second buffer.

20. A microphone signal authentication module for validating a first audio signal comprising:
a first input for receiving a first audio signal;
a second input for receiving a second audio signal generated by a second microphone;
an audio signal comparison module configured to compare a third audio signal derived from the first audio signal to a fourth audio signal derived from the second audio signal;
a determination block configured to determine, based on the comparison, whether the first audio signal and the second audio signal meet a predetermined condition, wherein the predetermined condition indicates that the first audio signal and the second audio signal are both derived from a common acoustic signal; and
a voice biometrics module configured to use the first audio signal as an input responsive to a determination that the first audio signal and the second audio signal meet the predetermined condition.
